(19) United States
(12) Patent Application Publication
(10) Pub. No.: US 2008/0024442 A1
(43) Pub. Date: Jan. 31, 2008

(54) Wireless cursor indicating device

(75) Inventor: Jerry Chen, Taipei (TW)

Correspondence Address: BACON & THOMAS, PLLC, 625 SLATERS LANE, FOURTH FLOOR, ALEXANDRIA, VA, 22314, US

(73) Assignee: ARESON TECHNOLOGY CORP., Taipel (TW)

(21) Appl. No.: 11/495,721

(22) Filed: Jul. 31, 2006

(51) Int. Cl. G09G 5/08

(52) U.S. Cl. 345/157

(57) ABSTRACT

A wireless cursor indicating device includes a first body and a second body combined with each other. The first body includes a containing space for containing a control circuit and a wireless receiver, and ends of the first and second bodies include a positioning member and a wheel, and a latch is disposed between the first and second bodies, such that the first and second bodies can be turned with respect to each other by the fixing member and wheel to define a closed status when the first and second bodies are stacked with each other or an open status when the first and second bodies are disposed alternately with each other. The first and second bodies can be disposed alternately with each other by the effect of the latch, such that a containing space is exposed to facilitate users to access or storage objects in the containing space.

### BACKGROUND OF THE INVENTION

1. Field of the Invention

The present invention relates to a wireless cursor indicating device, and more particularly to a wireless cursor indicting device having a first body and a second body rotably coupled and stacked with each other to define a closed status, and the first and second bodies at an open status can be fixed by a fixing member, such that the first and second bodies cannot be moved freely at the open status, and only a containing space for containing an object is exposed

2. Description of the Related Art

As mice have become a necessary computer peripheral, and a presentation indicator for controlling the operation of a computer also becomes a very important tool for speakers or presenters. In early days, a mouse must be connected to a computer through a transmission line for operating and controlling a computer, and such mouse is called a cable mouse. However the mice of this type are inconvenient because the transmission line is always in the way and the mouse cannot be placed at an appropriate position for its operation according to a user's habits. The presentation indicator can only project a light spot on a computer screen, such that if it is necessary to change the data displayed on the screen, users have to use a mouse to display the changed data on the screen.

To overcome the foregoing shortcomings, a wireless cursor indicator was introduced, and the wireless cursor indicator includes a wireless receiver connected to a computer by a transmission line (such as a USB cable), so that the control signals of the computer can be transmitted through the transmission line to the wireless receiver. As to the wireless receiver and wireless cursor indicator, the wireless cursor indicator includes a transmitter for sending the operating signal of the wireless cursor indicator to the wireless receiver, and the wireless receiver connects the computer and sends signals to the computer. In the meantime, the wireless cursor indicator also installs a light source to indicate the data on the computer screen, and the wireless cursor indicator installs one or two batteries for supplying the required power for the operation of the transmitter. Although the foregoing arrangement can solve the problems of the cable mouse or cursor indicator, the wireless receiver is a separate electronic part and cannot be integrated with the mouse or cursor indicator, and thus it makes the storage inconvenient. Although some existing wireless mice or cursor indicators provide a containing space and a latch at the bottom of the mouse or cursor indicator for accommodating and fixing the receiver therein. However, the application still has the problem that the receiver may be fallen out or protruded from the wireless mouse or cursor indicator.

### SUMMARY OF THE INVENTION

In view of the shortcomings of the prior art, the inventor of the invention based on years of experience in the related industry to conduct extensive researches and experiments, and finally developed a wireless cursor indicating device in accordance with the present invention.

Therefore, it is a primary objective of the present invention to provide a feasible solution and overcome the foregoing problems by providing a wireless cursor indicating device comprising a first body and a second body. The first body has a containing space disposed at an appropriate position of the first body for containing a control circuit and a wireless receiver, and the first and second bodies include a positioning member and a wheel engaged with each other, such that the first and second bodies can be rotably coupled with each other by the positioning member and the wheel to define a closed status when the first and second bodies are stacked, and the first and second bodies can be turned to an angle alternately with respect to each other by turning the wheel and fixing the positioning member to expose the containing space for containing objects, so as to achieve convenient storage, and fully contain the objects without exposing the objects.

Another objective of the present invention is to provide a wireless cursor indicating device, and its first and second bodies separately include corresponding latches corresponding to each other, such that when the first and second bodies are stacked, the limitation provided by the latch can prevent the first and second bodies from sliding with respect to each other.

A further objective of the present invention is to provide a wireless cursor indicating device, and its first and second bodies separately include an electric contact point, such that when the first and second bodies are stacked at a closed status, the electric contact points can electrically connect the circuits of the first and second bodies. On the other hand, the circuits are disconnected at an open status.

### BRIEF DESCRIPTION OF THE DRAWINGS

The objective, shape, structure, characteristic and effect of the present invention will now be described in more detail with reference to the accompanying drawings that show various embodiments of the invention, in which:

FIG. 1 is a perspective view of a first body and a second body stacked with each other in accordance with the present invention;

FIG. 2 is an exploded view of a first preferred embodiment of the present invention;

FIG. 3 is an exploded view of a first body of a first preferred embodiment of the present invention;

FIG. 4 is a schematic perspective view of placing an object at an open status when a first body and a second body are disposed alternately with each other in accordance with a first preferred embodiment of the present invention;

FIG. 5 is a top view of an open status when a first body and a second body are disposed alternately with each other in accordance with a first preferred embodiment of the present invention;

FIG. 6 is a top view of a first body and a second body stacked with each other in accordance with a first preferred embodiment of the present invention;

FIG. 7 is a top view of an open status in accordance with a first preferred embodiment of the present invention;

FIG. 8 is a perspective view of a second preferred embodiment of the present invention; and

FIG. 9 is a perspective view of a third preferred embodiment of the present invention.

### DETAILED DESCRIPTION OF THE PREFERRED EMBODIMENTS

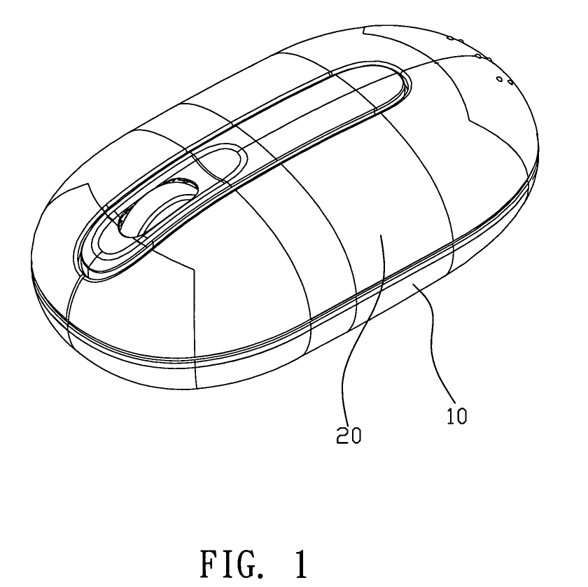

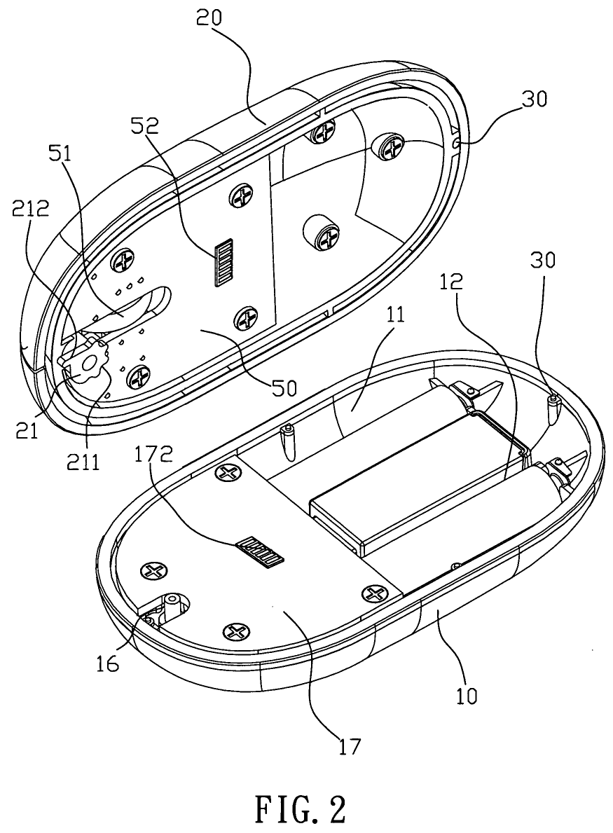

Referring to FIGS. 1, 2 and 3 for a wireless cursor indicating device (which is a wireless mouse in this embodiment, but the persons skilled in the art also could use an indicating cursor to substitute the wireless mouse), the wireless cursor indicating device is comprised of first and second bodies 10, 20 with a corresponding shape. In FIG. 2, the first body 10 includes a battery accommodating space 11 for containing a battery to supply the required power supply, and the first body 10 includes a containing space 12 in the accommodating space 11 for containing an object such as a wireless receiver or any other electronic part, and the first body 10 includes an optical control circuit 40 in other space, and the optical control circuit 40 in this embodiment is an optical control circuit board, but the persons skilled in the art can install related circuits of the control circuit.

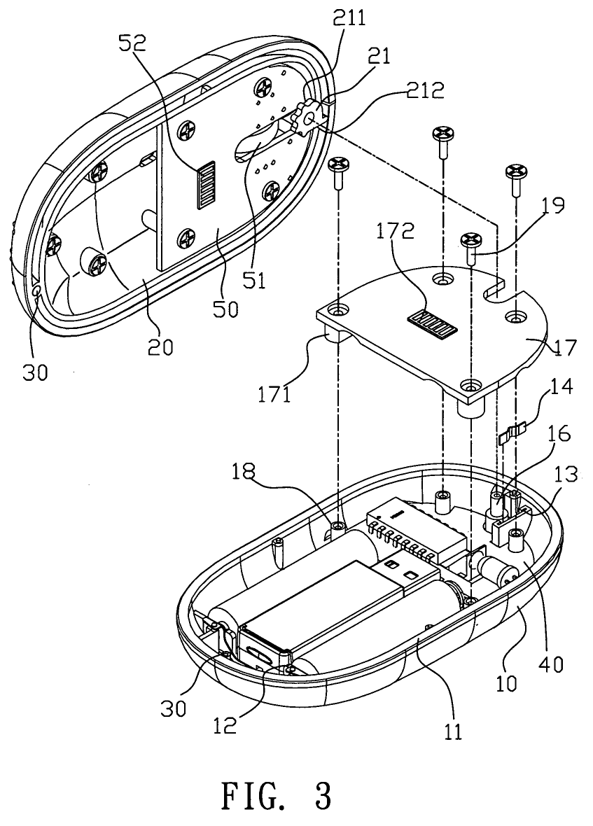

Referring to FIG. 3, the first body 10 has an embedding groove 13 disposed near a lateral side of the first body 10, and passed through the optical control circuit 40 and exposed thereon and a positioning member 14 embedded into the embedding groove 13, and the positioning member 14 is a spring in this embodiment, but the persons skilled in the art can substitute it with another equivalent component, and the embedding groove 13 has a corresponding pivotal base 16 near the embedding groove 13.

Further, the first body 10 has a frame 17 disposed on the optical control circuit 40 and pressing against the surface of the optical control circuit 40, and the frame 17 has a plurality of downwardly protruding bushings 171 disposed around the periphery of the frame 17 and engaged with the protruding pillar 18 of the first body 10. The protruding pillars 18 are disposed around the periphery of the optical control circuit 40 such that the frame 17 can be locked onto the optical control circuit 40 by passing the screw rods 19 through the bushings 171 and the protruding pillars 18, and the frame 17 has an electric contact point 172 coupled to the optical control circuit 40 and the battery.

Referring to FIG. 2, the second body 20 has a wheel 21 corresponding to a pivotal base 16 of the first body 10 and fixed to and protruded from the second body 20. However, the persons skilled in the art can substitute the wheel 21 by another equivalent component. The wheel 21 has a plurality of continuous recessions 211 disposed around the periphery of the wheel 21 and a vertical surface 212 coupled to the wheel 21, and the second body 20 has a latch 30 disposed on a surface corresponding to the first body 10, and the latch 30 is a protrusion or a recession in this embodiment, but the persons skilled in the art can substitute the latch 30 by another equivalent component for limiting and fixing the first and second bodies 10, 20 when the first and second bodies 10, 20 are stacked. The second body 20 has a control unit 50 and a roller 51 disposed at a position corresponding to the optical control circuit 40 of the first body 10, wherein the control unit 50 has an electric contact point 52 coupled to the control unit 50, such that the connection of electric contact points 172, 52 can electrically connect the optical control circuit 40 and the power supply of the first body 10 with the control unit 50 of the second body 20 to drive the wireless mouse. Since the operation of the wireless mouse is the same as that of a general wireless mouse, and thus will not be described here.

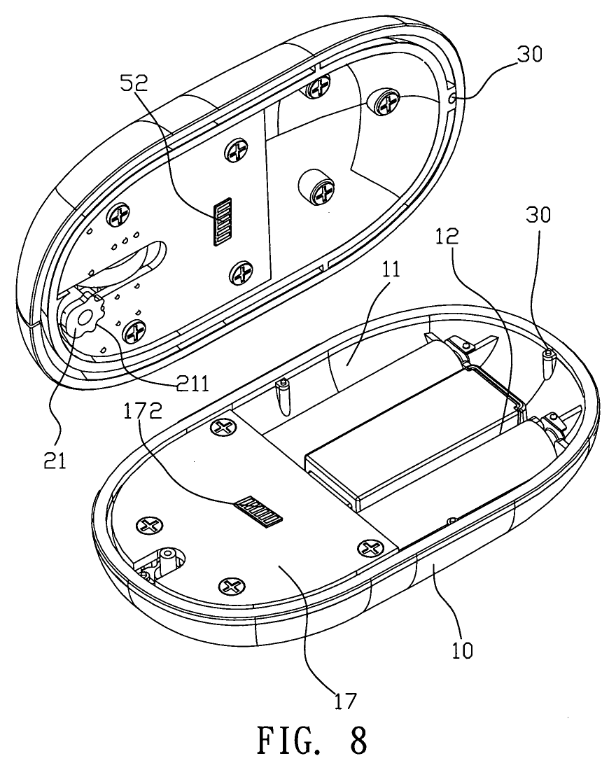

Referring to FIG. 8 for a second preferred embodiment of the present invention, the wheel 21 has a plurality of continuous recessions 211 disposed at the periphery of the wheel 21.

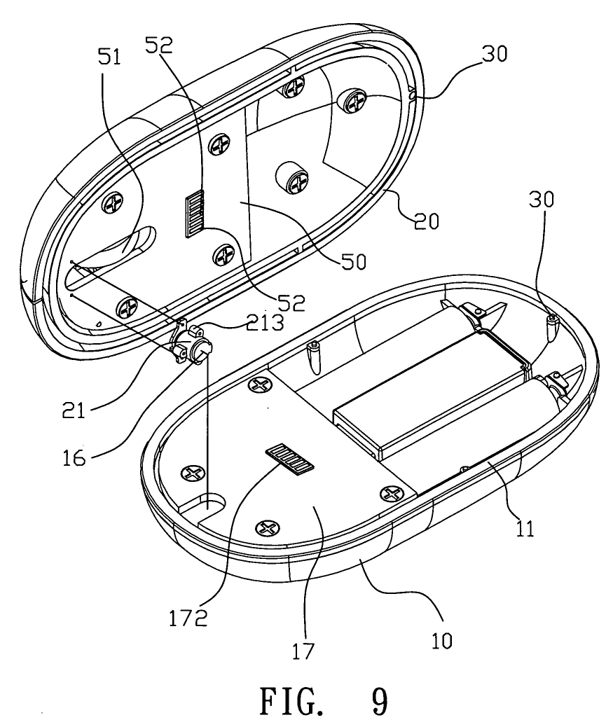

Referring to FIG. 9 for a third preferred embodiment of the present invention, the wheel 21 coupled by a cylinder pivotally coupled to the pivotal base 16, and the cylinder has a flange 213 protruded outward from the periphery of the cylinder.

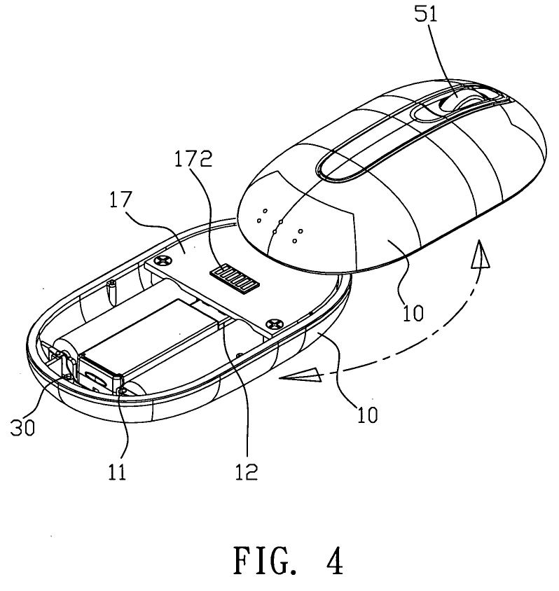

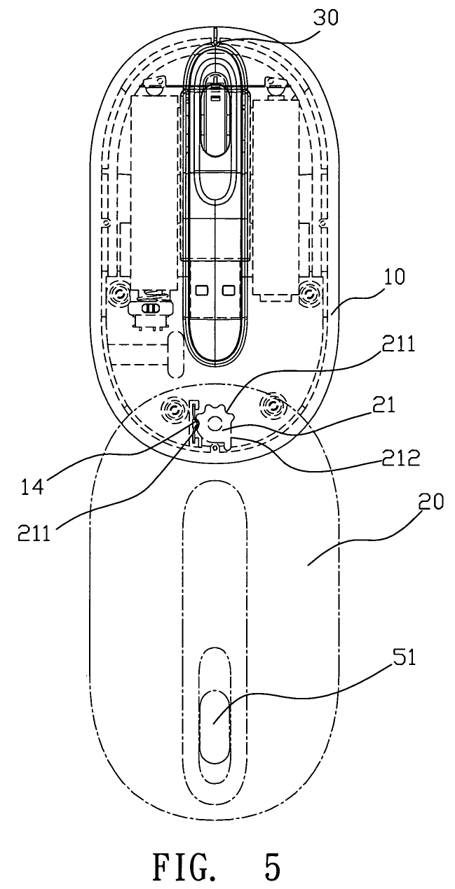

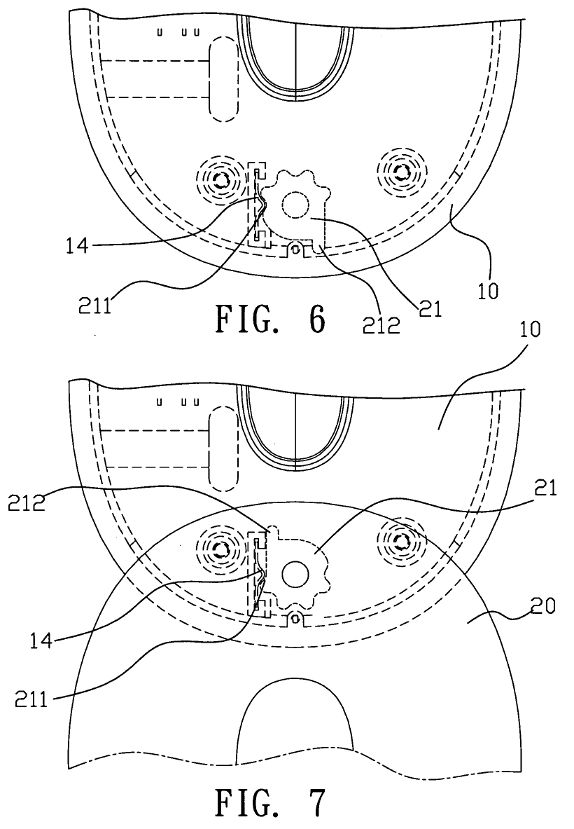

In the first preferred embodiment as shown in FIGS. 3 to 7, the mutually engaged latches 30 are separated first, and then the second body 20 is moved to the left or the right, so that the originally stacked first body 10 and second body 20 start moving alternately with each other, and the wheel 21 is driven by the second body 20, and one of the original recessions 211 latched into the positioning member 14 (as shown in FIG. 6) slides the recession 211 across the positioning member 14. In the sliding process, the positioning member 14 works in conjunction with the recession 211 and the vertical surface 212, so that the second body 20 is disposed alternately with the first body 10 at a specific angle (as shown in FIGS. 4, 5 and 7), and users can take an object (which is a wireless receiver in this embodiment) out from the first body 10 or install or replace the battery. When the first and second bodies 10, 20 resume their closed status, the limitation of the latch 30 can achieve the positioning effect, such that the first and second bodies 10, 20 are stacked with each other (as shown in FIGS. 1 and 6). In the closed status, the electric contact points 172, 52 of the first and second bodies 10, 20 are in contact, such that the power supply is electrically connected to the control circuit 40 and the control unit 50 (as shown in FIGS. 3 and 6).

In summation of the description above, the object, shape, structure of the present invention are novel and improve over the prior art and thus is duly submitted for the patent application. While the invention has been described by means of specific embodiments, modifications and variations could be made by those skilled in the art without departing from the scope and spirit of the invention set forth in the claims.

What is claimed is:

1. A wireless cursor indicating device, comprising:
a first body, having a containing space, for containing a control circuit and a wireless receiver, and a positioning member disposed on said first body; and
a second body, embedded into said first body, and having a wheel corresponding to said positioning member and pivotally coupled to said first body and being in contact with said positioning member;
thereby, said first and second bodies are stacked to define a closed status or disposed alternately to define an open status for exposing a containing space for containing object by said positioning member and said wheel.

2. The wireless cursor indicating device of claim 1, wherein said wireless cursor indicating device is a wireless mouse.

3. The wireless cursor indicating device of claim 1, wherein said positioning member is fixed into an embedding groove.

4. The wireless cursor indicating device of claim 1, wherein said positioning member is a spring.

5. The wireless cursor indicating device of claim 1, wherein said wheel has continuous recessions disposed along the periphery of said wheel.

6. The wireless cursor indicating device of claim 1, wherein said wheel has a flange disposed around the periphery of said wheel.

7. The wireless cursor indicating device of claim 1, wherein said second body has a latch disposed on a surface corresponding to said first body, such that said first and second bodies are latched with each other by said latch and cannot be rotated continuously when said first and second bodies are stacked.

8. The wireless cursor indicating device of claim 7, wherein said latch is a protrusion or a recession.

9. The wireless cursor indicating device of claim 1, wherein said first and second bodies separately include an electric contact point, such that when said first and second bodies are stacked at a closed status, the circuits of said first and second bodies are electrically coupled by said electric contact points.
